(19) United States
(12) Patent Application Publication
(10) Pub. No.: US 2013/0196423 A1
(43) Pub. Date: Aug. 1, 2013

(54) METHOD AND SYSTEM FOR PROCESSING ORGANIC WASTE

(71) Applicant: Micheal Bryan-Brown, Bainbridge Island, WA (US)

(72) Inventor: Micheal Bryan-Brown, Bainbridge Island, WA (US)

(21) Appl. No.: 13/741,304

(22) Filed: Jan. 14, 2013

Related U.S. Application Data
(60) Provisional application No. 61/586,003, filed on Jan. 12, 2012.

(51) Int. Cl. B09B 3/00

(52) U.S. Cl. CPC B09B 3/00
USPC 435/290.2

(57) ABSTRACT

The current application is directed to systems and methods for processing organic waste using aerobic bacterial digestion of organic waste. In one implementation, the system includes a covered enclosure with a non-porous floor and sidewalls within which a floor-scraping, helical auger with serrated or toothed edges is mechanically powered and translated in two dimensions in order to chop, mix, lift, and move composting organic waste towards a discharge end of the enclosure. The vessel additionally includes a rotatably mounted screen, in one implementation, for screening the composted organic waste as it is discharged. The vessel additionally includes, in one implementation, perforated, pressurized tubes for introducing pressurized air into the organic waste as it is processed as well as a flexible water hose for introducing moisture into the organic waste as it is being processed. Various sensors are employed to monitor and control the moisture, temperature, and other physical parameters of the organic waste by controlling rotation and translation of the helical, floor-scraping auger and, in certain implementations, controlling the pressure of pressurized air input into the perforated, pressurized tubes and the rate of water flow to the flexible water hose.

### CROSS-REFERENCE TO RELATED APPLICATION

This application claims the benefit of Provisional Application No. 61586003, filed Jan. 12, 2012.

### TECHNICAL FIELD

The current application is directed to composting of organic waste and, in particular, to a system and method for processing organic waste in optimal or near-optimal fashion in order to control odor, minimize unprocessed waste emissions, and maximize bacterial processing of the organic waste.

### BACKGROUND

Processing of organic waste, including discarded food and food-related materials and ground yard waste, is a commonly employed organic-waste-processing method that uses controlled bacterial digestion of organic waste to remove pathogens and break down organic waste into humus that is usable as a soil conditioner and fertilizer for gardening, landscaping, and agriculture. Many types of composting vessels and system have been developed, including rotating drums with porous surfaces, static or aerated piles with perforated floors, agitator-based systems with perforated floors, and other systems. However, in general, none of the currently available systems provide optimal control over emission of odors and wastes and optimal employment of aerobic bacterial digestion of the organic wastes. Gardeners, waste processors, farmers, and others who employ composting of organic waste and/or consume the end products of composting continue to seek effective new systems and methods for processing organic waste via composting and composting-related processes.

### SUMMARY

The current application is directed to systems and methods for processing organic waste using aerobic bacterial digestion of organic waste. In one implementation, the system includes a covered enclosure with a non-porous floor and sidewalls within which a floor-scraping, helical auger with serrated or toothed edges is mechanically powered and translated in two dimensions in order to chop, mix, lift, and move composting organic waste towards a discharge end of the enclosure. The vessel additionally includes a rotatably mounted screen, in one implementation, for screening the composted organic waste as it is discharged. The vessel additionally includes, in one implementation, perforated, pressurized tubes for introducing pressurized air into the organic waste as it is processed as well as a flexible water hose for introducing moisture into the organic waste as it is being processed. Various sensors are employed to monitor and control the moisture, temperature, and other physical parameters of the organic waste by controlling rotation and translation of the helical, floor-scraping auger and, in certain implementations, controlling the pressure of pressurized air input into the perforated, pressurized tubes and the rate of water flow to the flexible water hose.

### BRIEF DESCRIPTION OF THE DRAWINGS

FIG. 1 shows the organic-waste-processing system to which the current application is directed.

FIGS. 2A-B show internal components of the organic-waste-processing system.

FIGS. 3-5 illustrate the discharge end of the organic-waste-processing system.

FIG. 6 shows an alternative implementation of the organic-waste-processing system.

FIG. 7 illustrates the end of the helical, floor-scraping auger.

### DETAILED DESCRIPTION

The process of aerobically composting organic waste occurs in several stages and involves control of the biological environment to enhance degradation. Control parameters include moisture content, oxygen levels, particle size, and availability of degradable substances and nutrients. The process is dynamic and requires adjustment to rebalance parameters during the 20-60 day processing time. Moisture levels typically start at 55-65 percent and reduce to 35-45 percent by weight by the end of the process. The reduction in moisture is a result of biological heat generated during the compost process and the subsequent evaporation of moisture. The more degradation that occurs, the more moisture is lost. The composting waste may have to be rewetted several times during the process to maintain moisture levels required for bacterial growth. Particle size typically reduces during the process to allow bacteria fresh surface area for continued growth.

Organic waste materials such as food waste, sludge, and manures are typically contaminated with undesirable debris, such as plastic trash, medical waste, or other non-degradable substances. The process of composting organic waste materials into a reusable soil amendment typically involves screening to remove these objects at the end of the compost process before the compost is applied to land or sold at market. The compost is dried to 45 percent moisture or less for screening to occur. The fractionation of compost particles typically occurs by agitating the compost as it moves across a wire mesh or perforated plate deck.

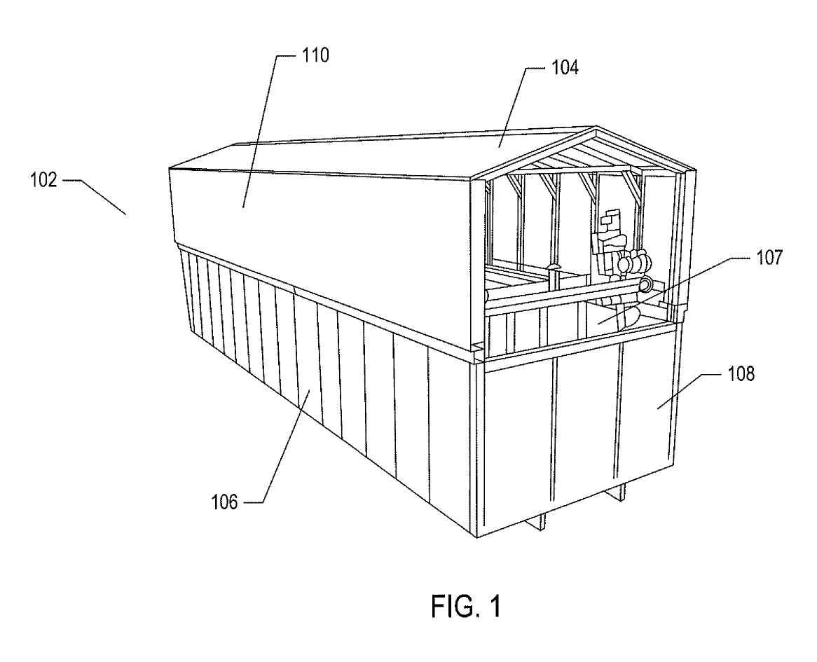

FIG. 1 shows the organic-waste-processing system to which the current application is directed. The organic-waste-processing system features an enclosure 102 including a roof 104, side walls 106-107, a loading-end wall 108, and a discharge-end wall (not shown in FIG. 1) at the opposite end of the enclosure that includes a rotatably mounted screen, both subsequently described and illustrated. The side walls, load-end wall, lower portion of the discharge-end wall, and a floor of the enclosure form a waste-impermeable vessel. The enclosure may be fully enclosed using a polymer-based permeable membrane, transparent plastic, or transparent glass 110 to cover the enclosure between the tops of the side and end walls and the roof.

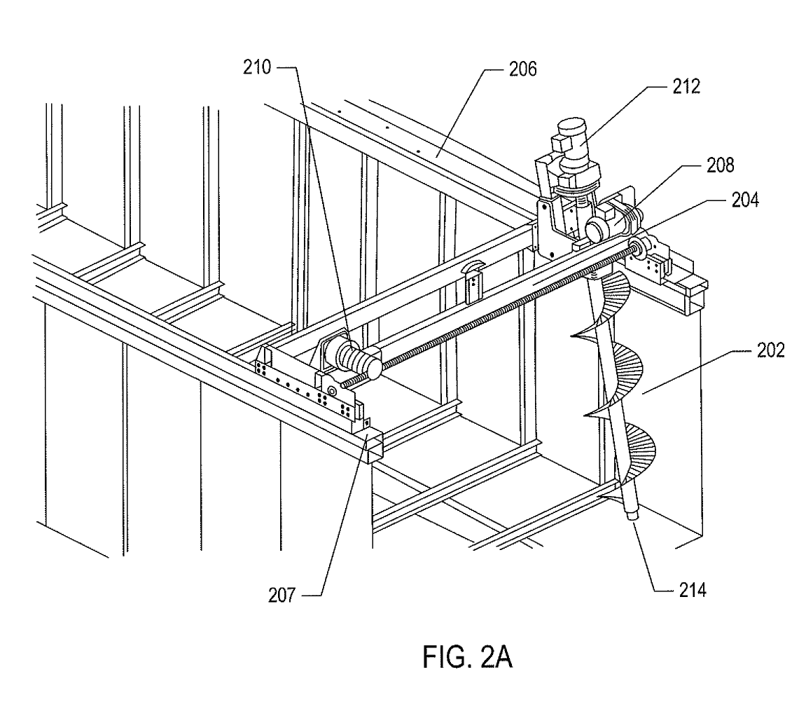

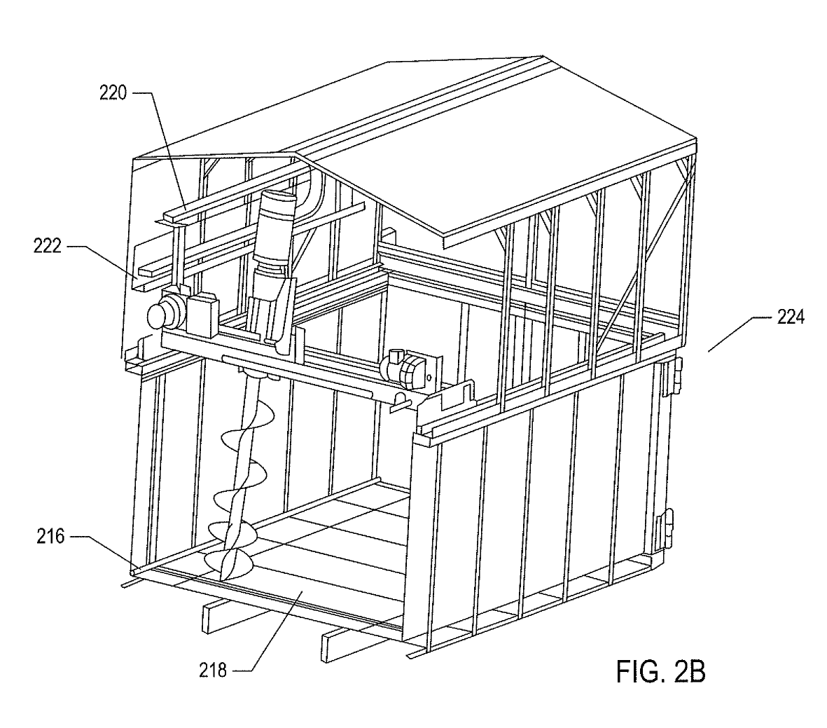

FIGS. 2A-B show internal components of the organic-waste-processing system. As shown in FIG. 2A, a rotating, helical, floor-scraping auger 202 is mounted to a translatable assembly 204. The translatable assembly is moved, under processor control, in a direction of the long dimension of the enclosure, along rails 206-207, by a first motor 208, and the auger is moved in an orthogonal direction, from one side of the enclosure to the other, within the translatable assembly 204 by a second processor-controlled motor 210. The auger is rotated by a third motor 212. As shown in FIG. 2A, the auger is generally inclined at between 10 and 20 degrees from the vertical direction in a vertical plane parallel to the long sides of the enclosure. The top of the auger is inclined towards the discharge end of the enclosure with respect to the lower end 214 of the auger.

FIG. 2B illustrates the internal components of the organic-waste-processing system from a different perspective. As shown in FIG. 2B, perforated air tubes, such as air tube 216, are mounted within the enclosure at the base of the side walls, above the flooring 218. The perforations are sized to provide velocity of pressurized air in the range of 50-150 feet per second, in one implementation. The tubes are connected to a high pressure blower externally mounted to the vessel for the addition of air for oxygenation and cooling. The blower delivers sufficient pressure to blow clogs out of the perforations in the tubing in the range of 0.5-2 PSI, in one implementation. Power is supplied to each of the motors via power cables, such as power cable 220, a greater portion of which lies along a lower track 222 as the translatable assembly moves towards the discharge end 224 of the organic-waste-processing system. Similar power-cabling-feeding mechanisms are employed to provide power to the other motors and may, in addition, be used to mount a flexible water hose to the translatable assembly to allow water to be spread across the surface of the organic waste within the enclosure as the auger is moved within the enclosure. By proper processor control of the two motors 208 and 210, the auger and water hose may be positioned anywhere within a two-dimensional plane parallel to the floor 218 of the enclosure, and may be controlled to traverse the enclosure in any of many different traversal patterns, including raster-like traversal patterns. A temperature sensor is attached to the lower portion of the helical, floor-scraping auger 202 in order to sense the temperature at various positions within the organic waste. Additional sensors may be attached to the auger, fixably mounted within the enclosure, or otherwise movably positioned within the enclosure to sense the moisture level, oxygen level, and other such physical parameters. Based on the sensor readings, a control program executed by a processor can select the traversal patterns, rotation speed of the auger, translation speed of the auger in both the lengthwise and sideways directions, and may additionally activate a valve to control flow of water through the water hose into the enclosure and activate valves or control the blower in order to control introduction of air into the enclosure. Any of many different types of sensors may be employed, including wireless sensors that communicate data by radio-frequency transmissions received by a wireless receiver coupled to the processor. The organic-waste-processing system additionally includes a physical control panel, electronic interfaces that allow the components of the organic-waste-processing system to be controlled from remote computing devices, including personal computers and cell phones, or both a physical control panel and one or more electronic interfaces.

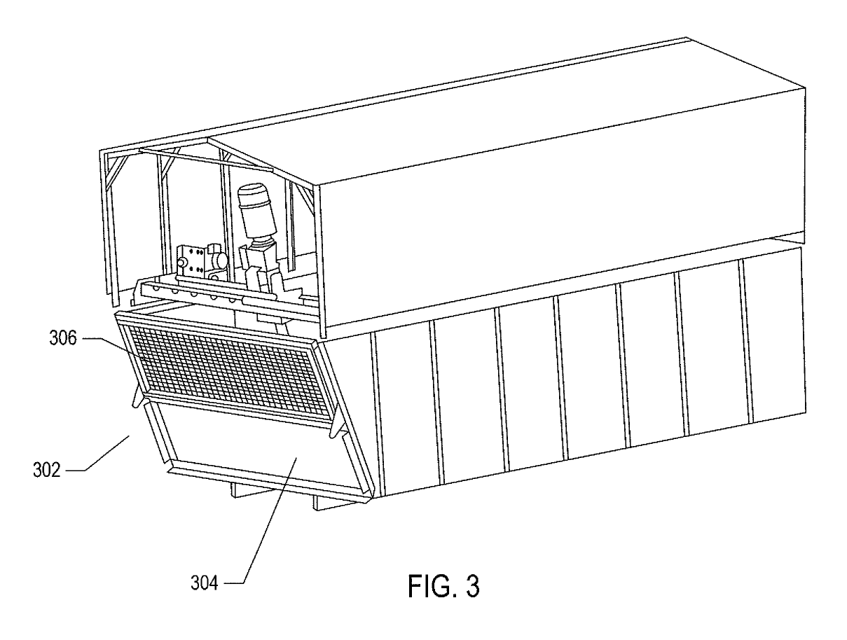

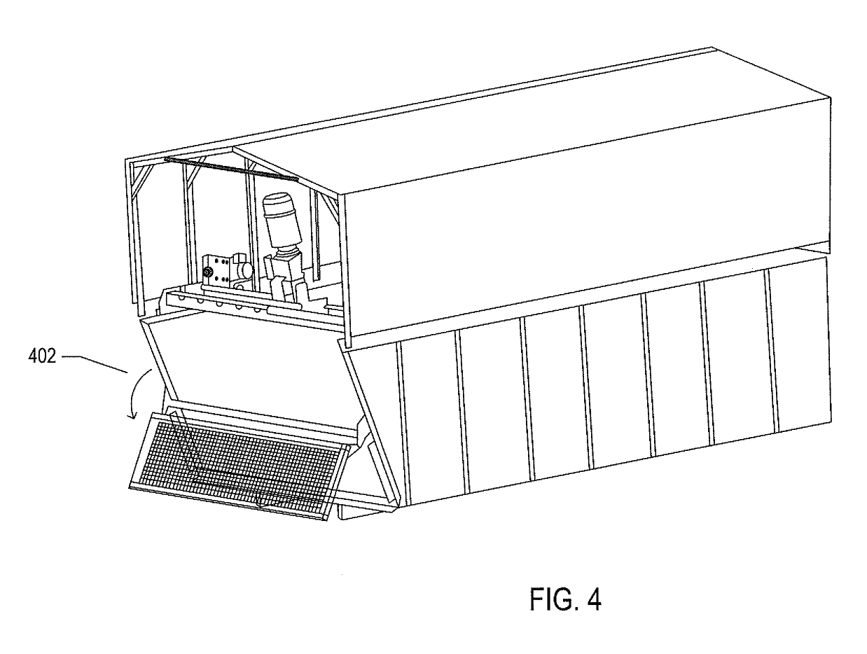

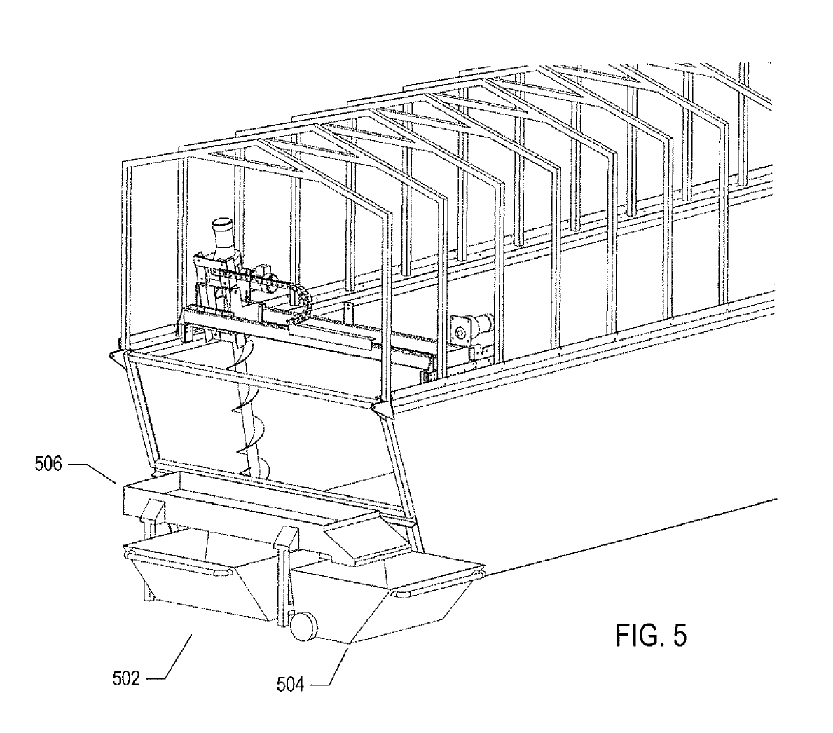

FIGS. 3-5 illustrate the discharge end of the organic-waste-processing system. The discharge end of the organic-waste-processing system 302 is inclined to the vertical at an angle similar to the inclination angle of the auger, and is parallel to the auger. The discharge end of the enclosure includes a lower, waste-impermeable wall 304 and an upper framed mesh or screen 306 that can be fixed parallel to the lower end wall 304 or unfixed and rotated 402, as shown in FIG. 4. The screen may additionally be mechanically vibrated or oscillated by one or more additional processor-controlled motors to facilitate separation of particles as processed organic waste passes through the screen into collection bins 502 and 504 shown in FIG. 5.

During operation, the organic waste is loaded into the load end the vessel by conveyor, bucket loader, or other means. The translatable assembly moves the auger to the load end of the vessel, stirring and shredding the organic waste as it biodegrades during the compost process. Additionally, the translatable assembly may move the auger side-to-side in the vessel. The pattern of motion of the auger determines the rate at which the organic waste is moved from the load end to the discharge end of the vessel. The control program can control auger movement according to a multitude of patterns to move organic waste at various speeds from the load end to the discharge end of the vessel and in the reverse direction. During the process of moving processed organic waste from one end to the other, the organic waste undergoes biological degradation, which generates heat and removes water by evaporation. Moisture is added back to the organic waste via the water hose mounted to the translation assembly. Removal of water from the compost reduces clumping and improves the screening process. The drying process can be further enhanced by enclosing the vessel with a light permeable membrane, allowing solar heat to warm the organic waste and accelerate the drying process. The drying process is accelerated by the addition of pressurized air at the base of the composting vessel to maintain optimum biological activity and heat generation. The pressurized air can be heated to further enhance the drying of the compost.

Once the organic waste reaches the discharge end of the vessel, the auger lifts the dried and composted material onto a screen, through which it drops onto a perforated deck 506 with holes sized to allow the fine organic material to drop through the holes into receiving bin 502 when the deck is vibrated. The larger particles are retained on the upper surface of the perforated deck and are discharged off the end of the deck into receiving bin 504 or allowed to accumulate on the ground. This sufficiently dries and sterilizes the larger particles for reuse as animal bedding while producing a fine compost product.

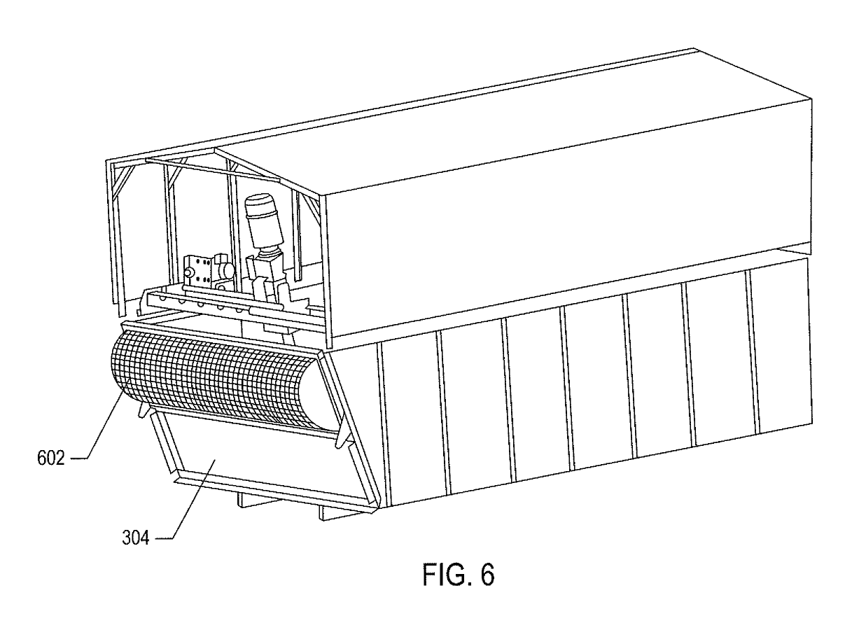

FIG. 6 shows an alternative implementation of the organic-waste-processing system. As shown in FIG. 6, the discharge-end screen 602 may be cylindrically shaped, rather than a plane above and parallel to the short discharge-end wall 304. This allows screened, processed organic waste to be continuously lifted and discharged to bins or other processing components positioned below, as the bins 502 and 504 and oscillating deck 506 are positioned in FIG. 5.

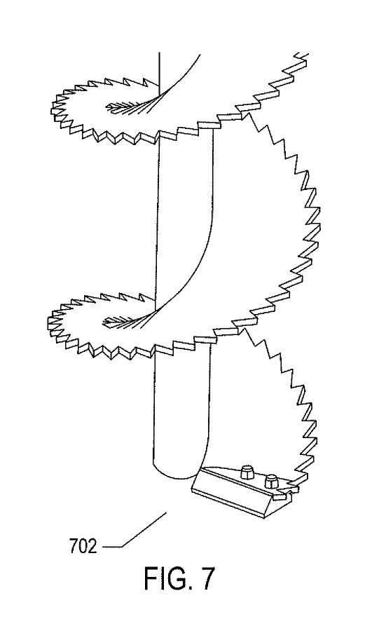

FIG. 7 illustrates the end of the helical, floor-scraping auger. The auger includes helical fighting, typically made of non-corrosive metal, that extends from the floor to near the top of the side walls. A radial-edge plastic shoe 702 is mounted to the bottom of the auger fighting, which allows contact between auger and floor without wearing the floor. The inclined angle of the auger promotes motion of the compost material from the load end to the discharge end of the vessel.

Although the present invention has been described in terms of particular embodiments, it is not intended that the invention be limited to these embodiments. Modifications within the spirit of the invention will be apparent to those skilled in the art. For example, the organic-waste-processing system may employ any of many different types of processor-coupled sensors in order to inform the control program of the current status of any of many different types of sensed physical parameters, from oxygen level, water moisture, and temperature to the presence of various types of bacterial-degradation chemical products. Additional mechanical controls may be employed to open and close apertures within the enclosure and to alter the amount of sunlight entering the enclosure in order to control temperature. Various additional mechanical features may be included in order to facilitate controlled discharge of processed organic waste from the enclosure. The dimensions, pitch, and number of teeth per linear dimension along the outer edge of the helical auger may all be varied in order to provide optimal mixing, shredding, and processed-organic-waste movement within the enclosure. In the illustrated embodiment, the processed organic waste is separated into fine particulate humus and larger particles, such as shavings, wood chips, and other fibrous materials that may be re-used for animal bedding. In alternative implementations, additional types of separation may be employed to partition the processed organic waste into a greater number of components. Additional mechanisms may facilitate removal of unwanted debris from the top of the screen, such as non-biodegradable plastics, metal objects, and other such debris.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An organic-waste-processing system comprising:
a processor that executes a control program;
an enclosure having two sides, a load end, a discharge end, and a floor that together form a waste-impermeable vessel, the two sides and a load-end wall vertically oriented, the floor horizontally oriented and perpendicular to the two sides and load-end wall, and the discharge end, perpendicular to the two sides, inclined outward at an inclination angle from the vessel, with the top of the discharge end further from the load end than the bottom of the discharge end, the discharge end comprising a short impermeable wall and a screen rotatably mounted to the short impermeable wall, the enclosure further including a roof;
a helical, floor-scraping auger that is rotated, under control of the control program, by a first motor;
a translation apparatus within the enclosure that moves, under processor control, the helical, floor-scraping auger, mounted to the translation apparatus at an inclination angle and parallel to the discharge end, within the enclosure in a first direction parallel to the two sides and in a second direction parallel to the load end;
a flexible water hose mounted to the translation apparatus to introduce water into the enclosure; and
at least one perforated air tube that introduces pressurized air into the enclosure along the bottom of the two sides.

2. The organic-waste-processing system of claim 1 further comprising a temperature sensor that transmits temperature information from within the enclosure to the processor.

3. The organic-waste-processing system of claim 1 wherein the temperature sensor is mounted to a lower-portion of the helical, floor-scraping auger and transmits temperature information by radio-frequency transmission.

4. The organic-waste-processing system of claim 1 further comprising an oxygen sensor that transmits oxygen-concentration information from within the enclosure to the processor.

5. The organic-waste-processing system of claim 1 further comprising am moisture sensor that transmits moisture information from within the enclosure to the processor.

6. The organic-waste-processing system of claim 1 wherein the control program controls the speed of rotation of the auger and the speed of translation of the auger in the first and second directions in order to establish and maintain a temperature within organic waste within the enclosure within a temperature range.

7. The organic-waste-processing system of claim 1 wherein the control program controls the speed of rotation of the auger and the speed of translation of the auger in the first and second directions in order to establish and maintain a moisture level within organic waste within the enclosure within a moisture-level range.

8. The organic-waste-processing system of claim 1 wherein the control program controls the speed of rotation of the auger and the speed of translation of the auger in the first and second directions in order to establish and maintain an oxygen-concentration level within organic waste within the enclosure within an oxygen-concentration-level range.

9. The organic-waste-processing system of claim 1 wherein the control program controls air pressure input to the at least one perforated air tube in order to maintain an oxygen-concentration level within organic waste within the enclosure within an oxygen-concentration-level range.

10. The organic-waste-processing system of claim 1 wherein the control program controls flow of water into the flexible water hose in order to maintain a moisture level within organic waste within the enclosure within a moisture-level range.

11. The organic-waste-processing system of claim 1 wherein the helical, floor-scraping auger chops, shreds, mixes, and moves processed organic waste within the enclosure.

12. The organic-waste-processing system of claim 1 wherein the helical, floor-scraping auger has a plastic foot with a forward edge parallel to the floor to lift processed organic waste from the floor.

13. The organic-waste-processing system of claim 1 wherein the control program controls movement of the auger to move processed organic waste from the load end to the discharge end of the enclosure.

14. The organic-waste-processing system of claim 1 wherein the processed organic waste is lifted by the auger over the short wall at the discharge end, where it falls onto the screen, which separates debris from the processed organic waste.

15. The organic-waste-processing system of claim 14 wherein the process organic waste, after falling through the screen, falls onto an oscillating perforated deck, with fine particles passing through the oscillating perforated deck to a first bin.

16. An organic-waste-processing system comprising:
a processor that executes a control program that controls the organic-waste-processing system to maintain temperatures, moisture, and oxygen within organic waste processed within the organic-waste-processing system in order to facilitate optimal or near-optimal bacterial degradation of the organic waste;
an enclosure having two sides, a load end, a discharge end, and a floor that together form a waste-impermeable vessel, the two sides and a load-end wall vertically oriented, the floor horizontally oriented and perpendicular to the two sides and load-end wall, and the discharge end, perpendicular to the two sides, inclined outward at an inclination angle from the vessel, with, the top of the discharge end further from the load end than the bottom of the discharge end, the discharge end comprising a short impermeable wall and a screen rotatably mounted to the short impermeable wall, the enclosure further including a roof;
a helical, floor-scraping auger that is rotated, under control of the control program, by a first motor; and
a translation apparatus within the enclosure that moves, under processor control, the helical, floor-scraping auger, mounted to the translation apparatus at an inclination angle and parallel to the discharge end, within the enclosure in a first direction parallel to the two sides and in a second direction parallel to the load end.

17. The organic-waste-processing system of claim 16 further including a flexible water hose mounted to the translation apparatus to introduce water into the enclosure.

18. The organic-waste-processing system of claim 16 at least one perforated air tube that introduces pressurized air into the enclosure along the bottom of the two sides.

19. The organic-waste-processing system of claim 1 wherein the control program controls the speed of rotation of the auger and the speed of translation of the auger in the first and second directions in order to establish and maintain a temperature within organic waste within the enclosure within a temperature range, to establish and maintain a moisture level within organic waste within the enclosure within a moisture-level range, and to establish and maintain an oxygen-concentration level within organic waste within the enclosure within an oxygen-concentration-level range.

20. The organic-waste-processing system of claim 1 further including one of a polymer-based membrane, transparent polymer panels, and, and glass panels to cover a space between the roof and the tops of the side walls of the enclosure.
